(19) United States
(12) Patent Application Publication
(10) Pub. No.: US 2009/0168636 A1
(43) Pub. Date: Jul. 2, 2009

(54) CANTILEVER DESIGN WITH ELECTROSTATIC-FORCE-MODULATED PIEZORESPONSE FORCE MICROSCOPY (PFM) SENSING

(76) Inventor: TSUNG-KUAN ALLEN CHOU, San Jose, CA (US)

Correspondence Address: INTEL CORPORATION;c/o CPA Global, P.O. BOX 52050, MINNEAPOLIS, MN, 55402, US

(21) Appl. No.: 11/967,721

(22) Filed: Dec. 31, 2007

(51) Int. Cl. G11B 9/00

(52) U.S. Cl. 369/126

(57) ABSTRACT

In one embodiment, the present invention includes an apparatus having a cantilever structure to move in a vertical direction, including a grounded cantilever body and a conductive tip, a vertical actuation electrode to actuate the cantilever to cause the conductive tip to contact a ferroelectric media surface, an AC electrostatic drive electrode to produce electrostatic forces to cause the cantilever structure to vibrate, and a sensing trace coupled with the conductive tip to sense charge generated by the ferroelectric media surface in response to a force applied by the conductive tip. Other embodiments are described and claimed.

### FIELD OF THE INVENTION

Embodiments of the present invention generally relate to the field of non-volatile memory, and more particularly to a cantilever design with electrostatic-force-modulated piezoresponse force microscopy (PFM) sensing.

### BACKGROUND

Seek-scan probe (SSP) memory is a type of memory that uses a non-volatile storage media as the data storage mechanism and offers significant advantages in both cost and performance over conventional charge storage memories. Typical SSP memories include storage media made of materials that can be electrically switched between two or more states having different electrical characteristics, such as resistance or polarization dipole direction.

SSP memories are written to by passing an electric current through the storage media or applying an electric field to the storage media. Passing a current through the storage media is typically accomplished by passing a current between a probe tip on one side of the storage media and an electrode on the other side of the storage media. Current SSP memories read storage media status by delivering a charge through probe tips positioned on the free end of one or more microelectromechanical systems (MEMS) probes and measuring a force response.

### BRIEF DESCRIPTION OF THE DRAWINGS

FIG. 1 is a block diagram of a memory device in accordance with one embodiment of the present invention.

FIGS. 2A and 2B are top and cross-sectional views of cantilever assemblies in accordance with embodiments of the present invention.

FIGS. 3A-3C are waveforms in accordance with one embodiment of the present invention.

FIG. 4 is a block diagram of a system in accordance with one embodiment of the present invention.

### DETAILED DESCRIPTION

In various embodiments, a cantilever design with electrostatic-force-modulated piezoresponse force microscopy (PFM) sensing is presented. In some embodiments the SSP cantilever is suspended by a torsional beam, which is anchored to a substrate or another suspended platform (e.g., a lateral actuation structure), although the cantilever structure does not need to be a torsional beam type.

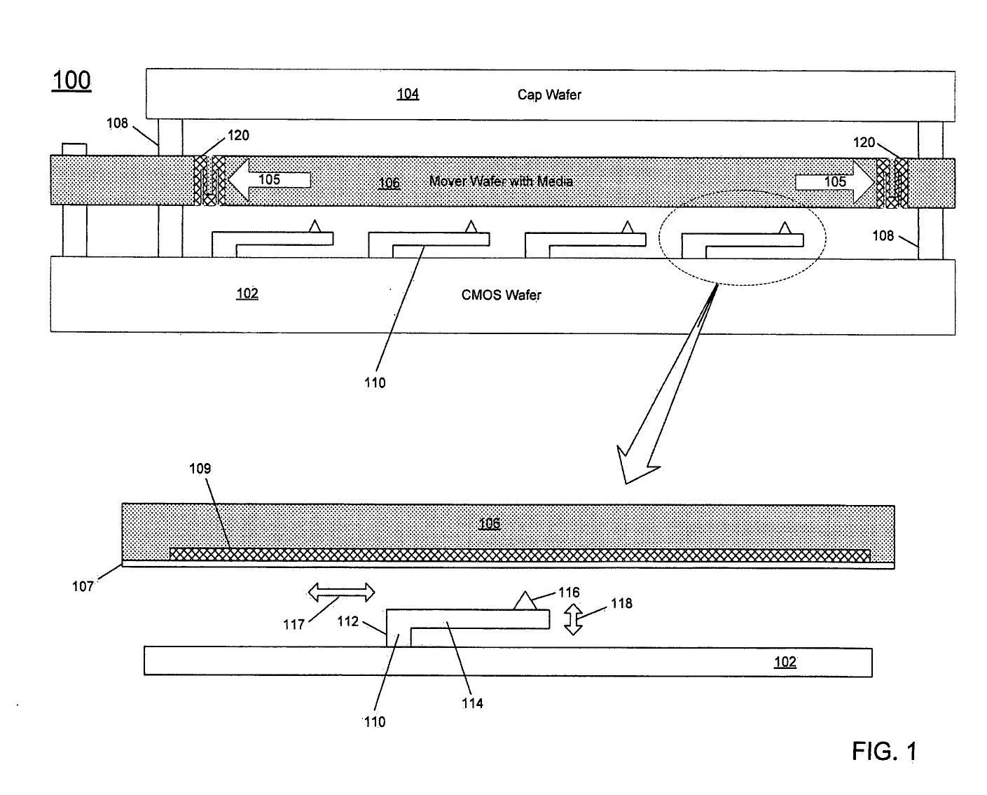

FIG. 1 illustrates an embodiment of a SSP memory 100. SSP memory 100 includes a CMOS wafer 102 over which a cap wafer 104 is positioned and supported by supports 108. Together, supports 108 and cap wafer 104 form a sealed enclosure within which a mover wafer 106 is suspended, also from supports 108, such that is it substantially parallel to the surface of CMOS wafer 102. As illustrated by arrows 105, mover wafer 106 is capable of motion relative to CMOS wafer 102 in a plane substantially parallel to the surface of the CMOS wafer (i.e., the x-y plane). One or more MEMS probes 110 are formed on a surface of CMOS wafer 102 so that the sharpened tip 116 of each MEMS probe 110 can come close to, and make contact with, the lower surface of mover wafer 106 when MEMS probes 110 are deflected vertically, as illustrated by arrow 118. As shown in FIG. 1, in various embodiments tip 116 may be adapted on a cantilever structure to enable PFM reading of data on mover wafer 106, as described hereinafter. That is, a force applied by tip 116 may cause contraction and extension of storage media on mover wafer 106, which may cause a PFM current to be produced which is then sensed through sharpened tip 116. Further as shown in FIG. 1, embodiments may include lateral movement of MEMS probe 110, as illustrated by arrow 117.

In addition to supporting the other components of SSP memory 100, CMOS wafer 102 can include therein circuitry that controls the operation of memory 100. Examples of circuitry that can be contained on CMOS wafer 102 include activation electrodes (not shown) that cause MEMS probes 110 to deflect upward toward mover wafer 106 and laterally; circuitry to send signals to sharpened tip 116 so that it can write data into storage media 107 on mover wafer 106; sensing and amplifying circuitry to receive, condition and amplify signals received through sharpened tip 116 when it reads data from storage media 107; memory to buffer and/or store data read from or written to, storage media 107; logic circuitry and/or software to encode and/or decode data that is written to or read from the storage media on mover wafer 106; and so forth.

As noted above, cap wafer 104 is supported over CMOS wafer 102 by supports 108. Together with supports 108, cap wafer 104 forms an enclosure within which mover wafer 106, cantilever probes 110, and other components of SSP memory 100 are housed.

Mover wafer 106 carries the storage media 107 on which SSP memory 100 writes data and from which it reads data. Mover wafer 106 can also include other elements such as electrode 109, which may be a media electrode, between storage media 107 and wafer 106 that facilitates reading and writing of data on storage media 107. Mover wafer 106 is supported between cap wafer 104 and CMOS wafer 102 by a suspension 120 coupled to supports 108. Suspension 120 provides electrical connections to the mover wafer and allows the mover wafer to move substantially parallel to the CMOS wafer, enabling memory 100 to change the x-y position at which the sharpened tips 116 of MEMS probes 110 read and write data to and from storage media 107. To enable mover wafer 106 to move in the x-y plane, SSP memory 100 also includes a drive mechanism (not shown) coupled to the mover wafer. In one embodiment, mover wafer 106 is composed of a single-crystal silicon, although in other embodiments polysilicon, silicon germanium (SiₓGe_{y}) or other variant of silicon may be used. Mover wafer 106 has a layer of storage media 107 deposited thereon on the surface of the wafer that faces MEMS probes 110. In one embodiment, storage media 107 is a ferroelectric material, although in other embodiments it can be a different type of material such as a chalcogenide or polymer material.

MEMS probes 110 are integrally formed on a surface of CMOS wafer 102. Although the illustrated embodiment shows the MEMS probes as cantilever-type probes, other embodiments can use other types of probes, such as see-saw-type probes; still other embodiments can include combinations of different types of probes. Each cantilever MEMS probe 110 includes a support or pedestal 112 formed on the surface of CMOS wafer 102 and a beam 114 that includes a fixed end attached to pedestal 112 and a free end opposite the fixed end. In the embodiment shown the beam 114 and pedestal 112 are integrally formed of the same material, but in other embodiments beam 114 and pedestal 112 need not be formed integrally and need not be formed of the same material. Examples of materials that can be used for pedestal 112 and/or beam 114 include polysilicon, single-crystal silicon, silicon germanium (SiₓGe_{y}), other materials not listed here, or combinations of materials. In one embodiment, the cantilever elements may be formed of polysilicon germanium (poly SiGe), as its processing temperature is compatible with CMOS wafer 102.

Each MEMS probe 110 includes a sharpened tip 116 at or near the free end of beam 114 such that when the free end of beam 114 is deflected toward storage media 107 a current can be passed through sharpened tip 116 to write data bits into the storage media. Reading of stored data may occur by sensing a PFM current generated by storage media 107 when a force is applied to it by sharpened tip 116. Thus each tip 116 is electrically coupled via beam 114 and pedestal 112, or via electrical traces in beam 114 and pedestal 112, to circuitry within CMOS wafer 102 that can read, write, amplify, decode, and perform other operations on data written to or read from storage media 107 by sharpened tip 116. In one embodiment each tip 116 is formed of amorphous silicon, although in other embodiments other types of materials can be used. Note that in some embodiments tip 116 may be coated with a conductive and wear-resistant material, such as platinum, although other materials may be used.

In one embodiment, cantilever MEMS probe 110 is electrically grounded in order to be vertically actuated by a bottom actuation electrode. When a DC voltage is applied to the actuation electrode, electrostatic force rotates the see-saw beam until its tip contacts the ferroelectric media surface above. When an alternating current (AC) drive signal is applied to an isolated drive electrode on beam 114, electrostatic forces modulate the contact force between sharpened tip 116 and storage media 107. The contraction and extension of the ferroelectric media causes a PFM current to be generated which is sensed through sharpened tip 116. In order to minimize the required voltage, the AC drive signal can be set close to the cantilever resonant frequency. The DC voltage may be removed from the actuation electrode to separate sharpened tip 116 from storage media 107 to allow storage media 107 to be moved relative to MEMS probe 110 to different x and/or y locations.

While the scope of the present invention is not limited in this regard, some embodiments may provide from about 3 to about 5 thousand MEMS probes 110 in about a 1.5 cm² area, providing about 16 gigabytes (GB) or storage capacity.

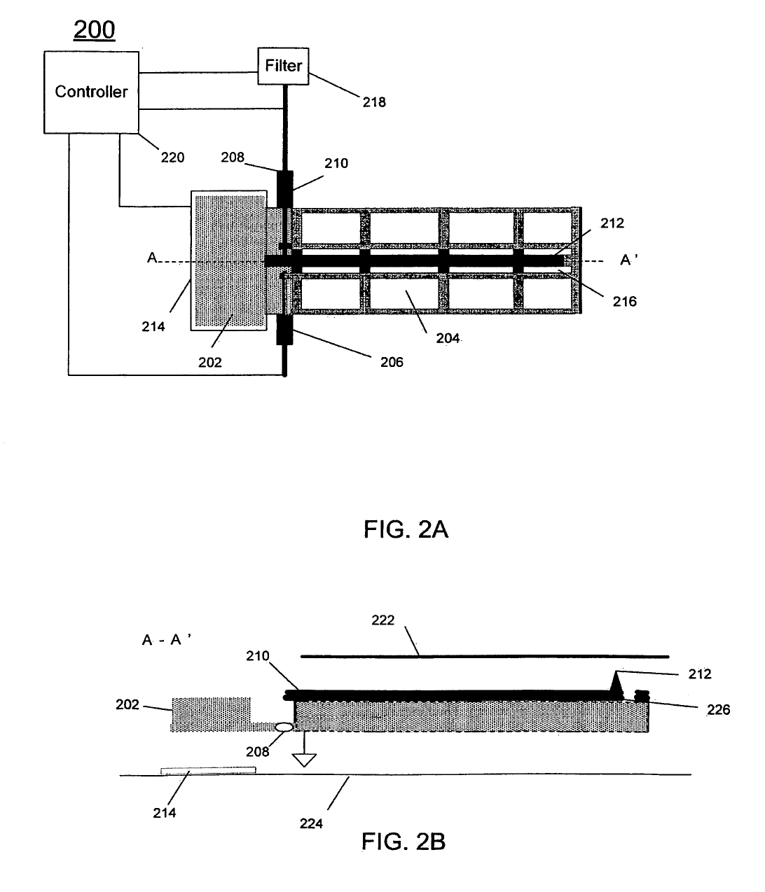

Referring now to FIGS. 2A and 2B, shown are top and cross-sectional views of a cantilever assembly in accordance with an embodiment of the present invention designed to move in a vertical direction and formed on a substrate 224, which in various embodiments may include CMOS circuitry as described above. As shown, cantilever assembly 200 includes cantilever body 202, AC electrostatic drive electrode 204, AC trace 206, torsional beam 208, sensing trace 210, conductive tip 212, vertical actuation electrode 214, air gap 216, filter 218, controller 220, media surface 222, substrate 224, and dielectric 226.

Cantilever body 202 is grounded for signal integrity reasons. Cantilever body 202 may be comprised of a material that produces electrostatic forces when a voltage is applied. A DC voltage may be applied to vertical actuation electrode 214 causing cantilever body 202 to move vertically and causing conductive tip 212 to press against media surface 222. An AC voltage may be applied to AC electrostatic drive electrode 204 through AC trace 206 causing cantilever body 202 to vibrate and causing the force between conductive tip 212 and media surface 222 (a ferroelectric media) to fluctuate. As the force between conductive tip 212 and media surface 222 fluctuates, the contraction and extension of the ferroelectric media causes a PFM current to be generated which is sensed conducted through conductive tip 116 and sensing trace 210. In one embodiment, conductive tip 212 has a height of about 1 micrometer.

Torsional beam 208 may be included in some see-saw cantilever embodiments, though the present invention is not limited in this respect, to support cantilever body 202 on substrate 224 and to provide a pivot point about which cantilever body 202 may rotate. Sensing trace 210 may be supported by or routed through torsional beam 208 to circuitry on or in substrate 224 in some embodiments. To reduce parasitic capacitance on sensing trace 210, cantilever assembly 200 may include dielectric 226 between sensing trace 210 and cantilever body 202 in some embodiments. Also, air gap 216 may exist in cantilever body 202 in some embodiments to further reduce parasitic capacitance between AC electrostatic drive electrode 204 and sensing trace 210.

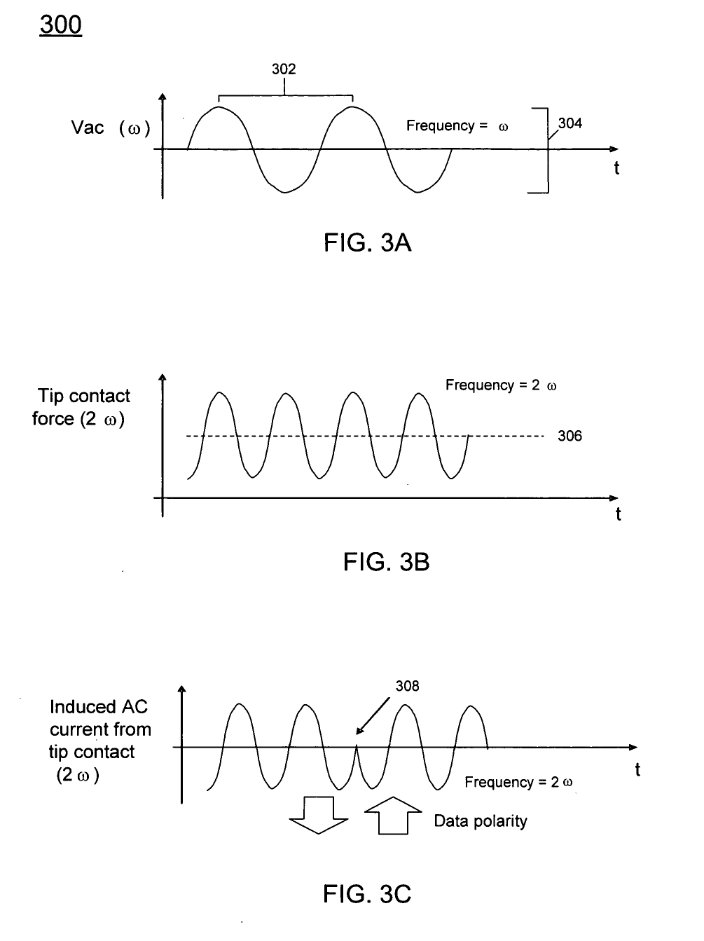

Controller 220 and filter 218 represent circuitry which may be incorporated into substrate 224. Controller 220 may control the operation of cantilever assembly 200 to read from and write to media surface 222. In one embodiment, controller 220 provides a DC voltage to vertical actuation electrode 214 and an AC voltage to AC electrostatic drive electrode 204. In one embodiment, the AC voltage provided may be represented by the sinusoidal waveform for FIG. 3A. In one embodiment, the peak-to-peak amplitude 304 is from about 2 to about 5 volts and period 302 is about 2 microseconds (with the frequency ω being about 500 kilohertz). As the DC and AC voltages are applied, conductive tip 212 will apply a fluctuating force against media surface 222, for example as represented by FIG. 3B. In one embodiment, the resulting force will have a frequency of 2ω and fluctuate by about 100 nanonewtons about the DC contact force component 306 of about 150 nanonewtons. In one embodiment, PFM charge generated by media surface 222 is transmitted by sense trace 210 to filter 218, which may be a band pass filter to only allow signals at a frequency of 2ω to pass through to controller 220. Controller 220 may receive a waveform, for example the waveform represented in FIG. 3C, and determine the status of the media surface 222 being read by detecting changes in polarity in the induced current, such as demonstrated at time 308. Controller 220 may also be able to write data to media surface 222 by sending a DC voltage through sensing trace 210 and conductive tip 212. Other circuitry and components may be needed to control and interface cantilever assembly 200 that are not shown here, but would occur to one skilled in the art.

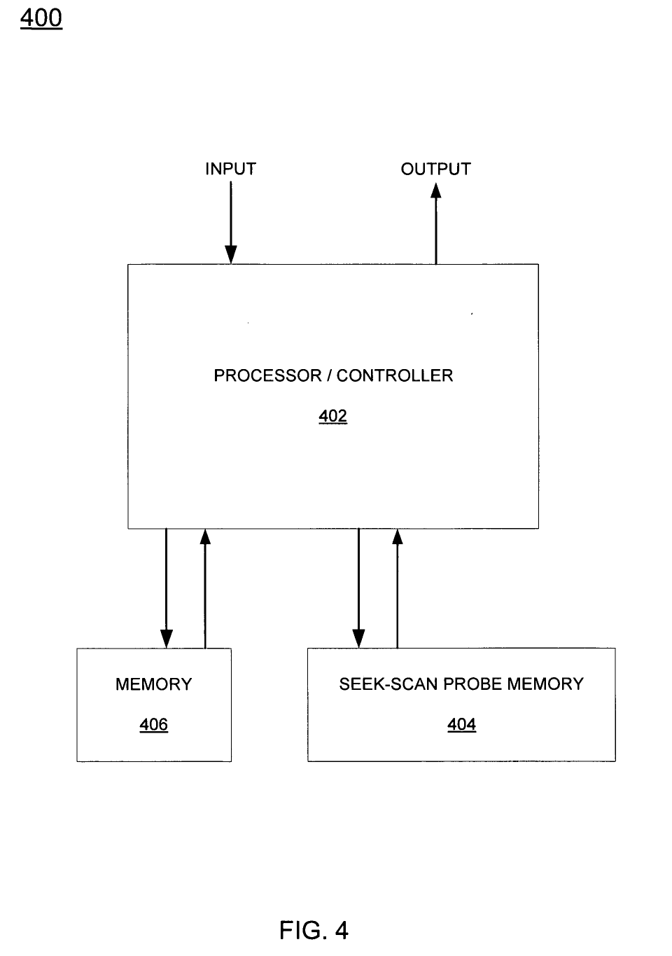

FIG. 4 illustrates an embodiment of a system 400 that includes a SSP memory using one or more MEMS probes. System 400 includes a processor 402 to which is coupled a memory 406 and an SSP memory 404. Processor 402, in addition to being coupled to memories 406 and 404, has an input and an output through which it can receive and send data, respectively. In one embodiment processor 402 can be a general-purpose microprocessor, although in other embodiments processor 402 can be another type of processor, such as a programmable controller or an application-specific integrated circuit (ASIC).

Memory 406 can be any type of volatile or non-volatile memory or storage. Volatile memories that can be used in different embodiments of memory 406 include random access memory (RAM), dynamic random access memory (DRAM), synchronous random access memory (SRAM) and synchronous dynamic random access memory (SDRAM), erasable programmable read only memory (EPROM), electrically erasable programmable read only memory (EEPROM), and the like. SSP memory 404 can, in different embodiments, be a memory that includes one or more MEMS probes formed in accordance with an embodiment of the present invention.

In operation of system 400, processor 402 can receive and send data through its input and output, and can both read and write data to both the memory 406 and the SSP memory 404. Through appropriate software, processor 402 can control the reading, writing and erasure of data in SSP memory 404 by changing the relevant media property (phase change, electric dipole formation, etc) of the storage media used in the SSP memory.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a cantilever structure to move in a vertical direction, including a grounded cantilever body and a conductive tip;
a vertical actuation electrode to actuate the cantilever to cause the conductive tip to contact a ferroelectric media surface;
an AC electrostatic drive electrode to produce electrostatic forces to cause the cantilever structure to vibrate; and
a sensing trace coupled with the conductive tip to sense charge generated by the ferroelectric media surface in response to a force applied by the conductive tip.

2. The apparatus of claim 1, further comprising a torsional beam to support the cantilever structure and to provide a pivot point about which the cantilever structure may rotate.

3. The apparatus of claim 1, wherein the AC electrostatic drive electrode provides an AC source to cause the cantilever structure to vibrate at a resonant frequency.

4. The apparatus of claim 1, further comprising a band pass filter coupled with the sensing trace to filter out noise from an induced current.

5. The apparatus of claim 4, further comprising logic to sense a change in polarity in the induced current.

6. The apparatus of claim 1, wherein the conductive tip comprises a height of about 1 micrometer.

7. The apparatus of claim 1, wherein the AC electrostatic drive electrode provides a sinusoidal AC source with an amplitude of from about 2 to about 5 volts and with a frequency of greater than about 500 kilohertz.

8. The apparatus of claim 1, wherein the cantilever body comprises dielectric material.

9. The apparatus of claim 8, wherein the cantilever body comprises an air gap separating the sensing trace from the AC electrostatic drive electrode.

10. The apparatus of claim 1, wherein the vertical actuation electrode force provides a DC contact force of about 150 nanonewtons.

11. The apparatus of claim 1, wherein the AC electrostatic drive electrode provides an AC contact force of about 100 nanonewtons.

12. A method comprising:
applying a force to a ferroelectric media by causing a cantilever structure with a conductive tip in contact with the ferroelectric media to vibrate;
sensing charge generated by the ferroelectric media through the conductive tip coupled with a sensing trace; and
determining a stored status of the ferroelectric media based on the polarity of the sensed charge.

13. The method of claim 12, further comprising filtering the sensed charge with a band pass filter to pass signals at an induced frequency.

14. The method of claim 12, wherein causing the cantilever structure to vibrate comprises providing a sinusoidal AC source to produce electrostatic forces of about 100 nanonewtons.

15. The method of claim 12, further comprising holding the cantilever structure in contact with the ferroelectric media by applying a DC voltage to a vertical actuation electrode.

16. The method of claim 15, further comprising removing the DC voltage from the vertical actuation electrode and moving the ferroelectric media relative to the cantilever structure.

17. A system comprising:
a media wafer including a ferroelectric medium layer and a common electrode layer;
a substrate including complementary metal oxide semiconductor (CMOS) circuitry;
a microelectromechanical systems (MEMS) probe formed on the substrate and movable to a location adjacent the ferroelectric medium layer, the MEMS probe including:
a cantilever structure to move in a vertical direction, including a grounded cantilever body and a conductive tip;
a vertical actuation electrode to actuate the cantilever to cause the conductive tip to contact the ferroelectric medium layer;
an AC electrostatic drive electrode to produce electrostatic forces to cause the cantilever structure to vibrate; and
a sensing trace coupled with the conductive tip to sense charge generated by the ferroelectric medium layer in response to a force applied by the conductive tip.

18. The system of claim 17, further comprising a torsional beam to support the cantilever structure and to provide a pivot point about which the cantilever structure may rotate.

19. The system of claim 17, further comprising a band pass filter coupled with the sensing trace to filter out noise from an induced current.

20. The system of claim 19, further comprising logic to sense a change in polarity in the induced current.
